(19) United States
(12) Patent Application Publication
(10) Pub. No.: US 2006/0013495 A1
(43) Pub. Date: Jan. 19, 2006

(54) Method and apparatus for processing image data

(75) Inventors: Ling Yu Duan, Singapore (SG); Ruowei Zhou, Singapore (SG); Juel Hoi Tang, Singapore (SG); Chun Biao Guo, Singapore (SG); Guo Yu Quian, Singapore (SG); Lei Zhao, Singapore (SG)

Correspondence Address: GREENBLUM & BERNSTEIN, P.L.C., 1950 ROLAND CLARKE PLACE, RESTON, VA, 20191, US

(73) Assignees: Vislog Technology Pte Ltd. of Singapore; Agency for Science, Technology and Research of Singapore

(21) Appl. No.: 11/039,883

(22) Filed: Jan. 24, 2005

Related U.S. Application Data
(63) Continuation of application No. 10/483,992.

(51) Int. Cl. G06K 9/46

(52) U.S. Cl. 382/235

(57) ABSTRACT

A network camera apparatus is disclosed including an image requisition unit which obtains an analog signal of an image and converts this into digital format; an image compression unit which utilizes standard image compression techniques (JPEG, MJPEG) to decrease the data size; an image processing unit which analyzes the compressed data of each image, detects motion from compressed data, and identifies background and foreground regions for each image; a data storage unit which stores the image data processed by the image processing unit; a traffic detection unit which detects the traffic amount of the network and decides the frame rates of the image data to be transmitted; and a communication unit which communicates with the network to transmit the image data and other signals.

This application is a continuation of pending U.S. patent application Ser. No. 10/483,992, filed Jan. 23, 2004, which is a National Stage Application of PCT/SG01/00158, filed Jul. 25, 2001, the disclosures of which are expressly incorporated herein by reference in their entireties.

### FIELD OF THE INVENTION

The present invention generally relates to a method and apparatus for processing image data, more particularly but not exclusively for a surveillance application.

### BACKGROUND OF THE INVENTION

Video surveillance cameras are normally used to monitor premises for security purposes. A typical video surveillance system usually involves taking video signals of site activity from one or more video cameras, transmitting the video signals to a remote central monitoring point, and displaying the video signals on video screens for monitoring by security personnel. In some cases where evidentiary support is desired for investigation or where “real-time” human monitoring is impractical, some or all of the video signals will be recorded.

It is common to record the output of each camera on a time-elapse video cassette recorder (VCR). In some applications, a video or infrared motion detector is used so that the VCR does not record anything except when there is motion in the observed area. This reduces the consumption of tape and makes it easier to find footage of interest. However, it does not eliminate the need for the VCR, which is a relatively complex and expensive component that is subject to mechanical failure, frequent tape cassette change, and periodic maintenance, such as cleaning of the video heads.

Another proposed approach is to use an all-digital video imaging system, which converts each video image to a compressed digital form immediately upon capture. The digital data is then saved in a conventional database. Solutions of this approach can be divided into three categories. The first category makes use of digital video recorders with or without network interface. This category is relatively expensive. It requires a substantial amount of storage space. The second category is framegrabber based hardware solutions. In this category, a framegrabber PC is used with traditional video cameras attached to it. The disadvantages of this category include: lack of flexibility, heavy cabling work, and high cost. Compared to the first two categories, the third category—a network camera based solution, possesses favourable features. In a network camera based surveillance solution, the cabling is simpler, faster and less expensive. The installation is not necessarily permanent since the cameras can easily be moved around a building. The distance from the camera to the monitoring/displaying/storage station can be very long (in principle worldwide). Moreover, network camera based solutions can achieve performance comparable with the first two categories. A network camera developed by Axis is able to transmit high-quality streaming video at 30(NTSC) or 25(PAL) images per second with enough bandwidth.

In digital video surveillance systems, as video data is relatively large in data amount terms, it is necessary to reduce the data amount by coding/compressing the digital video data. If video data is compressed, more video information can be transmitted through a network at high speed. Among various compression standards, JPEG and Motion JPEG (MJPEG) are the most widely used. The reason is that, although H.261, H.263, and MPEG compression methods can generate a smaller data stream, some image details 25 will inevitably be dropped which might be crucial in identifying an intruder. Using JPEG or Motion JPEG, the image quality is always guaranteed. U.S. Pat. No. 5,379,122, and the book JPEG: Still Image Compression Standard, New York, N.Y.: Van Nostrand Reinhold, 1993 by W. B. Pennebaker and J. L. Mitchell, gives a general overview of data-compression techniques which are consistent with JPEG device-independent compression standards. MJPEG is a less formal standard used by several manufacturers of digital video equipment. In MJPEG, the moving picture is digitized into a sequence of still image frames, and each image frame in an image sequence is compressed using the JPEG standard. Therefore, a description of JPEG suffices to describe the operation of MJPEG. In JPEG compression, each image frame of an original image sequence which is desired to be transmitted from one hardware device to another, or which is to be retained in an electronic memory, is first divided into a two-dimensional array of typically square blocks of pixels, and then encoded by an JPEG encoder (apparatus or a computer program) into compressed data. To display JPEG compressed data, a JPEG decoder (normally a computer program) is used to decompress the compressed data and reconstruct an approximation of the original image sequence therefrom.

Although JPEG/MJPEG compression preserves the image quality, it makes the compressed data size relatively bigger. It will take about 3 seconds to transmit a 704×576 size color image with reasonable compression level through a ISDN 2B link. Such a transmission speed is not acceptable in surveillance applications. By observing the camera setting environment in surveillance applications, one can easily find that the camera position is always fixed. That is, the images captured by surveillance camera will always consist of two distinct regions: background region and foreground region. The background region consists of the static objects in the scene while the foreground region consists of objects that move and change as time progresses. Ideally, background regions should be compressed and sent to the receiver only once. By concentrating bit allocation on pixels in the foreground region, more efficient video encoding can be achieved.

Means for segmenting a video signal into different layers and merging two or more video signals to provide a single composite video signal is known in the art. An example of such video separation and merging is presentation of weather-forecasts on television, where a weather-forecaster in the foreground is first segmented from the original background and then superimposed on a weather-map background. Such prior-art means normally use a color-key merging technology in which the required foreground scene is recorded using a colored background (usually blue or green). If a blue pixel is detected in the foreground scene (assuming blue is the color key), then a video switch will direct the video signal from the foreground scene to the background scene at that point. If a blue pixel is not detected in the foreground scene, then the video switch will direct the video from the background scene to the foreground scene at that point. Examples of such video separation and merging technique include U.S. Pat. Nos. 4,409,611, 5,923,791, and an article by Nakamura et al. in SMPTE Journal, Vol. 90, Feb. 1981, p. 107. The key feature of this type of methods is the pre-set background color. This is feasible in media production applications but is absolutely impossible in a surveillance application.

To perform foreground/background segmentation in a general environment, some image/video encoders have been proposed. U.S. Pat. No. 5,915,044 describes a method of encoding uncompressed video images using foreground/background segmentation. The method consists of two steps: a pixel level analysis and a block level analysis. During the pixel level, interframe differences corresponding to each original image are thresholded to generate an initial pixel-level mask. A first morphological filter is applied to the initial pixel-level mask to generate a filtered pixel-level mask. During the block level, the filtered pixel-level mask is thresholded to generate an initial block-level mask. A second morphological filter is preferably applied to the initial block-level mask to generate a filtered block-level mask. Each element of the filtered block-level mask indicates whether the corresponding block of the original image is part of the foreground or background.

Patent EP0833519 introduced an enhancement to the standard JPEG image data compression technique which includes a step of recording the length of each string of bits corresponding to each block of pixels in the original image at the time of compression. The list of lengths of each string of bits in the compressed image data is retained as an “encoding cost map” or ECM. The ECM, which is considerably smaller than the compressed image data, is transmitted or retained in memory separate from the compressed image data along with some other accompanying information and is used as a “key” for editing or segmentation of the compressed image data. The ECM, in combination with a map of DC components of the compressed image, is also used for substituting background portions of the image with blocks of pure white data, in order to compress certain types of images even further. This patent is meant for digital printing. It uses the bit length and DC coefficient of each block of pixels to analyse and segment the image into regions with different characteristics, for example, text, halftone, and contone regions. The ‘background’ in this patent denotes regions with less detail, that is totally different from the background definition in surveillance applications: portions of the scene that do no significantly change from frame to frame. The method of this patent cannot be used in foreground/background separation for surveillance applications.

Besides patents, some research work, especially MPEG-4 related, has also been published in this area. The paper “Check Image Compression using a layered coding method”, J. Huang and etc., Journal of Electronic Imaging, Vol. 7, No. 3, pp. 426442, July 1998, introduced a method to segment and encode a check image into different layers.

All of these known approaches have been generally adequate for their intended purposes, but they are not satisfactory in surveillance network camera applications.

Patents describing various network cameras or network camera related surveillance systems are proposed in the prior art. U.S. Pat. No. 5,926,209 discloses a video camera apparatus with compression system responsive to video camera adjustment. Patent JP7015646 provides a network camera which can freely select the angle of view and the shooting direction of a subject. Patent EP0986259 describes a network surveillance video camera system containing monitor camera units, a data storing unit, a control server, and a monitor display coupled by a network. Japanese patent application provisional publication No. 9-16685 discloses a remote monitor system using a data link ISDN. Japanese patent application provisional publication No. 7-288806 discloses that a traffic amount is measured and the resolution is determined in accordance with the traffic amount. U.S. Pat. No. 5,745,167 discloses a video monitor system including a transmitting medium, video cameras, monitors, a VTR, and a control portion. Although some of the network cameras use image analysis techniques to perform motion detection, none of them is capable of background/foreground separation, encoding, and transmission.

It is an object of the invention to provide an image processing method and apparatus suitable for a surveillance application which alleviates at least one disadvantage of the prior art noted above and/or provides the public with a useful choice.

### SUMMARY OF THE INVENTION

According to the invention in a first aspect, there is provided a method of processing image data comprising the steps of taking a compressed version of an image and determining from the compressed version if a change in the image compared to previously obtained image data has occurred and identifying the changed portion of the compressed image.

An image processor arranged to perform the method of the first aspect is also provided.

According to the invention in a second aspect, there is provided a method of processing compressed data derived from an original image, the data being organized as a set of blocks, each block comprising a string of bits corresponding to an area of the original image, Direct Cosine Transformation (DCT) coefficients for each block being derived by decoding each string of bits, the differences between the DCT coefficients of the current frame and the DCT coefficients of a previous frame or a background frame being thresholded for each frame to produce an initial mask indicating changed blocks, applying segmentation and morphological techniques to the initial mask to filter out noise and find regions of movement, if no moving region is found, regarding the current frame as a background frame, otherwise identifying the blocks in the moving regions as foreground blocks and extracting the foreground blocks to form a foreground frame

According to the invention in a third aspect, there is provided network camera apparatus comprising an image requisition unit arranged to capture an image and converts the image into digital format; an image compression unit arranged to decrease the data size; an image processing unit arranged to analyze the compressed data of each image, detect motion from the compressed data, and identify background and foreground regions for each image; a data storage unit arranged to store the image data processed by the image processing unit; a traffic detection unit arranged to detect network traffic and set the frame rates of the image data to be transmitted; and a communication unit arranged to communicate with the network to transmit the image data.

According to the invention in a fourth aspect, there is provided a method of transmitting image data where the data has been split into foreground data and background data wherein the foreground and background data are transmitted at different bit rates.

According to the invention in a fifth aspect there is provided a method of forming a changed image from previous image data and current image data identifying a change in a portion of the previous image comprising replacing a corresponding portion of the previous image data with the current image data to form the changed image.

In the described embodiment a video encoding scheme for a network surveillance camera is provided that addresses the bit rate and foreground/background segmentation problems of the prior art. All the important image details can be kept during encoding and transmission processes and the compressed data size can be kept low. The proposed video encoding scheme identifies all the stationary objects in the scene (such as door, wall, window, table, chair, computer, and etc.) as background regions and all the moving objects (people, animal, and etc.) as foreground regions. After separating the image frames into foreground regions and background regions, the video encoding scheme sends background data in low frequency and foreground data in high frequency. If the number of images captured by a network camera in each second is 25, the total number of frames captured will be 30×60×25=45000 for 30 minutes. If each image has a size of 50 kbyte (after JPEG compression), the total size will be 2.25 Gbyte. In an indoor room environment, however, the room may be empty at most of the time. Assuming that out of 30 minutes, the time people are moving in the room is 10 minutes and the area occupied by the moving people is one eighth of the whole image area. By using the proposed foreground/background separation and transmission scheme, the total data can be further compressed to a much smaller size of 93.8 Mbyte. Thus, the network camera of the described embodiment of the present invention is able to produce a much smaller image stream of the same quality when compared with a traditional network camera. In the example given above, the size of image data generated by a network camera of the described embodiment of the present invention is only one twenty fourth of that of a traditional network camera. By separating foreground-moving objects from background, the described embodiment has another advantage over the traditional network camera: high-level information such as size, color, classification, or moving directions of foreground objects can be easily extracted from the foreground objects and used in video indexing or intelligent camera applications.

### BRIEF DESCRIPTION OF THE DRAWINGS

Embodiments of the invention will now be described, by way of example, with reference to the accompanying drawings, in which:

FIG. 1 is a block diagram of the network camera with foreground/background segmentation and transmission, according to a preferred embodiment of the present invention;

FIG. 2 is a diagram illustrating how the JPEG compression technique is applied to an original image in the image compression unit of FIG. 1;

FIG. 3 is a flow diagram of a preferred embodiment of the image processing unit of FIG. 1;

FIG. 4 is a flow diagram of another preferred embodiment of the image processing unit of FIG. 1;

FIG. 5 is a flow diagram of the third preferred embodiment of the image processing unit of FIG. 1;

FIG. 6 is a flow diagram of the fourth preferred embodiment of the image processing unit of FIG. 1;

FIG. 7 is an example of an original image;

FIG. 8 is the segmented foreground blocks corresponding to FIG. 7;

FIG. 9 is an example of a compressed video stream after image compression and foreground/background segmentation;

FIG. 10 is a block diagram of a receiver which receives the compressed video stream from the network camera of FIG. 1, and composites foreground and background data into normal JPEG images, according to a preferred embodiment of the present invention;

FIG. 11 is a block diagram illustrating how a receiver of FIG. 8 receives a data stream (consisting of background and foreground data), unpacks the data stream, and forms a normal JPEG image sequence for displaying; and

FIG. 12 illustrates Zig-Zag processing.

### DESCRIPTION OF THE PREFERRED EMBODIMENTS

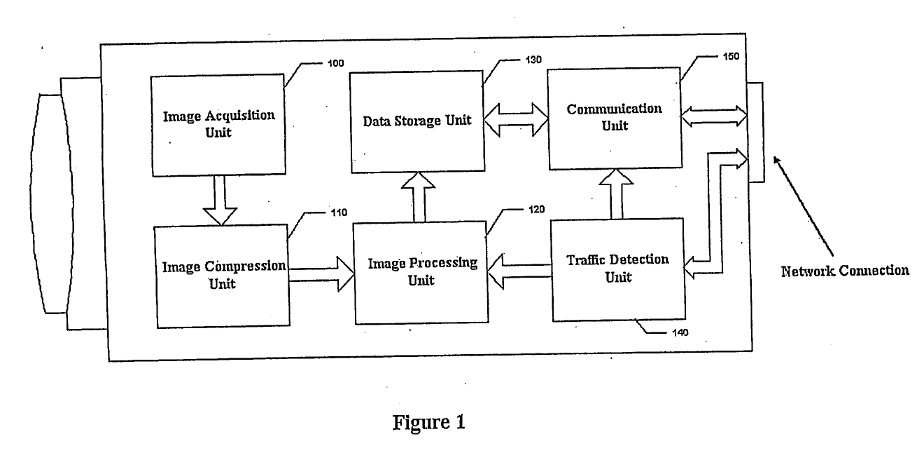

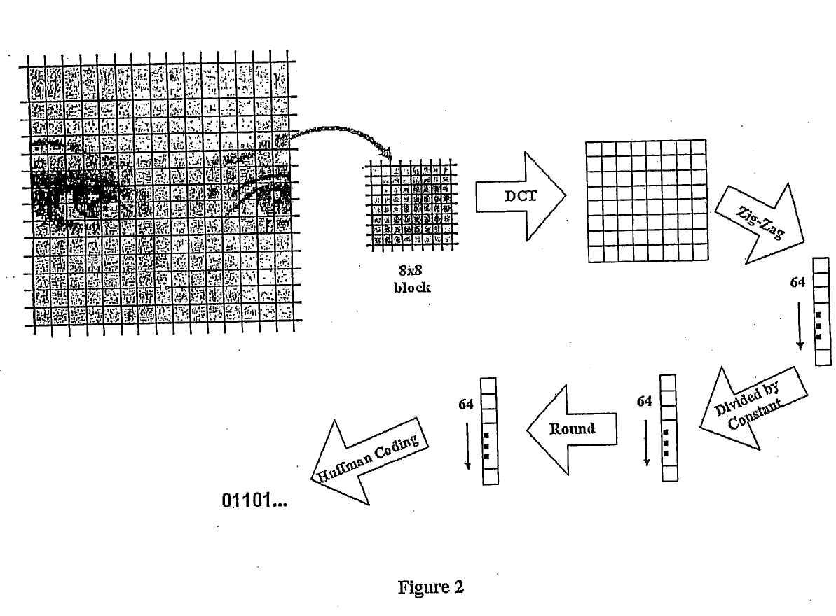

FIG. 1 is a block diagram of a network camera which embodies the present invention. The network camera includes an image acquisition unit 100, an image compression unit 110, an image processing unit 120, a data storage unit 130, a traffic detection unit 140, and a communication unit 150. The network camera in the disclosed embodiment can be a monochrome camera, color camera, or some other type of camera which will produce two-dimensional images—such as an infrared camera. The image requisition unit 100 of FIG. 1 consists of a CCD or CMOS image sensor device which converts optical signals into electrical signals, and a AID converter which digitizes the analog signal and converts it into a digital image format. The network camera can accept a wide range of bits per pixel, including the use of colour information. The image compression unit 110 of FIG. 1 can be a software program or a circuit—which is commonly found in network cameras on the market The operation of the image compression unit is given in FIG. 2 as described below. After image compression, the JPEG-compressed data is passed to the image processing unit 120 for motion detection and background/foreground separation. By comparing the current image frame with a previous image frame or the stored background image frame, the image processing unit 120 is able to detect whether there is a motion or not. If no motion is detected, the current image frame is treated as a background image frame. Otherwise, the current image frame is treated as a foreground image frame and the foreground regions are identified. For a background image frame, the whole image data (JPEG-compressed data) is deposited into the data storage unit For a foreground image frame, however, only the data of foreground regions is saved into the data storage unit 120. The data storage unit 120 receives the image data from the image processing unit and stores the data in a sequential way that is ready for transmission. The traffic detection unit 140 detects the traffic amount on the network and decides the frame rates of the background image data to be saved into the data storage unit, the JPEG compression rate of the compression unit, the foreground padding value of the image processing unit, and the frame rates of the image data to be transmitted. The image data stored in the data storage unit is packed, encrypted, and transmitted by the communication unit 150. Supplementary information such as camera ID, image frame type—background or foreground frame is added to image data during the packing process.

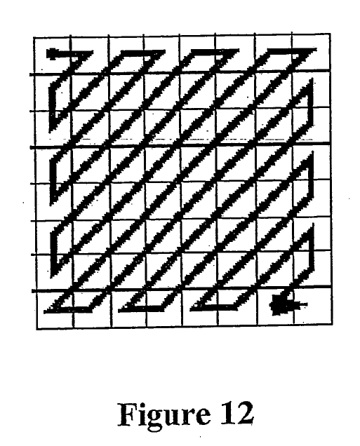

FIG. 2 gives the main steps of the JPEG compression standard used in the described embodiment. JPEG compression starts by breaking the image into 8×8 pixel blocks. The standard JPEG algorithm can handle wide range of pixel values. For colour images, each pixel in the image will have a three byte value, indicating RGB, YUV, YCbCr, or etc. For grey-level images, as the example shown in FIG. 2, each pixel of the image will have a single byte value, that is, a value between 0 and 255. The next step of JPEG compression is to apply Discrete Cosine Transform (DCT) to each 8×8 block of pixels and transform the block into frequency domain coefficients. When the CDT is taken of an 8×8 block of pixels, it produces a new 8×8 block of spatial frequencies. After the transformation, the set of coefficients represent successively higher-frequency changes within the block in both the x and y directions. F(0,0) (the upper left corner) represents the rate of no change in either direction, ie. it is the average of the 8×8 input values, and is known as the DC coefficient. This allows separation of the much more noticeable low-frequency information from the higher frequencies—which contain the fine detail and can be removed without too much picture degradation. The third step of JPEG compression is to transform the 8×8 DCT coefficients into a 64-element vector by using zig-zag coding. The zig-zag coding is shown in FIG. 12.

In the JPEG compression so far, there are 64 DCT coefficients each of which has a real value. Given the fact that high frequency DCT coefficients occur less and actually make less visual impact on the image, it makes sense to only use 1 or 2 bits to represent high frequency DCT coefficients and 8 bits to represent low frequency DCT coefficients with precision. This results in compression with almost no perceptible difference to humans. This step of reducing the number of bits representing DCT coefficients is called quantization. For each JPEG compressed image, there is a quantization table that determines how many bits represent each DCT coefficient. Each DCT coefficient is divided by a quantization coefficient (a constant in the quantization table), and rounded to the nearest integer. The quantization step can be used to vary the amount of compression. If only a couple of bits are used to represent each coefficient, then there will be high compression at the cost of a fuzzy image. Similarly, all the bits could be used (but compressed) for an exact replica of the original image. The reduced, and weighted DCT coefficients are next coded using the Huffman coding method.

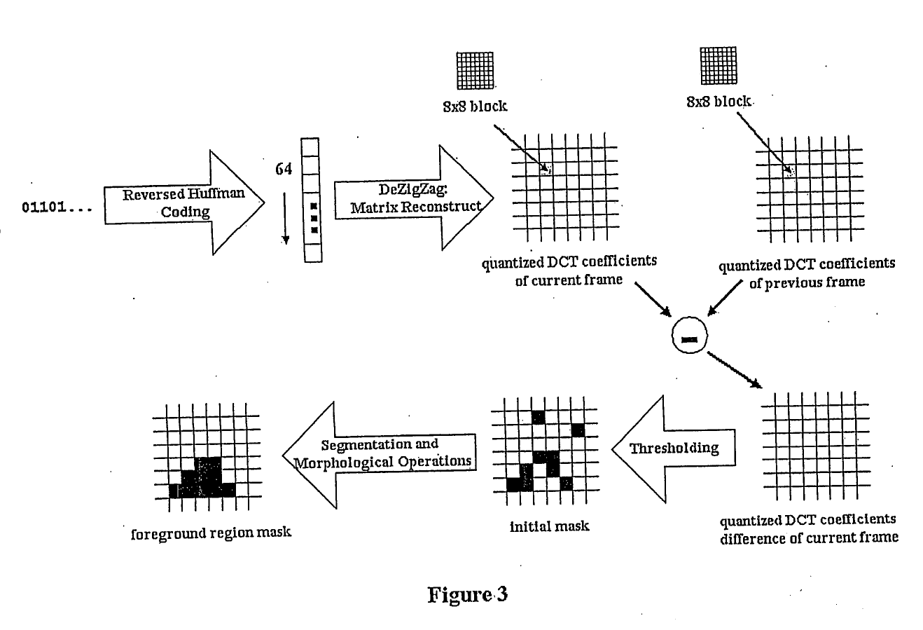

FIG. 3 to FIG. 6 show different approaches of performing motion analysis and foreground/background separation in the image processing unit 120 of FIG. 1. From these figures, it can be observed that the input to the image processing unit is JPEG-compressed data. The reason is that, the image compression is normally realized by a hardware circuit in network cameras. An approach could be to decompress the data into grey-scale or color values, process it, and compress the result but it is much more computationally efficient to perform image analysis directly on compressed data. However, due to the use of Huffman coding at the last stage of JPEG coding, it is difficult to derive semantics directly from the JPEG compressed data. Thus reverse Huffman coding is performed and motion analysis and foreground/background separation is carried out based on quantized or dequantized DCT coefficients. As DC components of DCT coefficients reflect average energy of pixel blocks and AC components reflect pixel intensity changes useful information can be derived directly based on DCT coefficients.

As shown in FIG. 3, the JPEG-compressed data is processed by reverse Huffman coding to recover the 64-element vector data. After that, DeZigZag processing is applied to reconstruct the 8×8 quantized DCT coefficients block from the vector data. The quantized DCT coefficient differences between the current frame and the previous frame are calculated and thresholded to yield an initial mask indicating changing blocks. In the compressed domain, processing including thresholding, segmentation, and morphological operations are all block based. The DC coefficient of each block can be used alone or together with AC coefficients in the compressed domain processing. Once the initial mask is derived, standard segmentation techniques and morphological operations (for example as described in B. C. Smith, & L. A. Rowe, “Algorithms for manipulating compressed images”, IEEE Computer Graphics and Applications, vol. 13, no. 5, pp. 3442, September 1993) are used-to filter out noise and find foreground regions. If no foreground region is found, the current frame is identified as a background frame and the whole image (JPEG-compressed image) is deposited into the data storage unit of FIG. 1. If a foreground region is found, only the blocks of the foreground region are extracted. Zig-zag coding and Huffman coding are applied to these foreground blocks. The resultant compressed data with the positional information of blocks in the foreground region will be packaged together and saved into the data storage unit. The quantized DCT coefficients of the current frame are saved into a storage buffer of the image processing unit 110 and used to compare with the next frame.

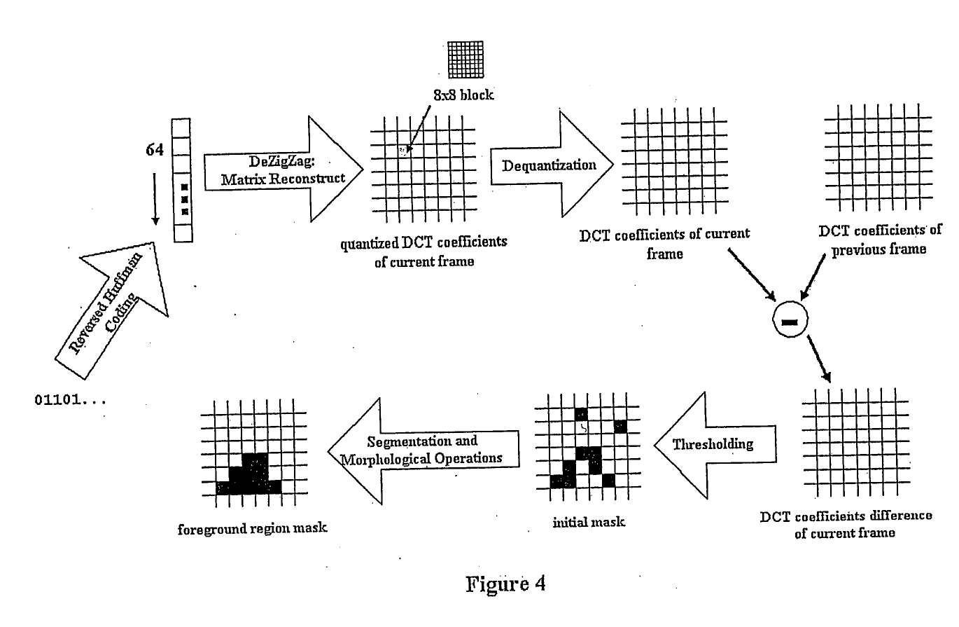

FIG. 4 is similar to FIG. 3 in most of the operations. The only difference is that instead of quantized DCT coefficient, dequantized DCT coefficients are used in the compressed domain image processing shown in FIG. 4. The 8×8 quantized DCT coefficients blocks are dequantized by multiplying the DCT coefficients with the quantization factors used in the compression step. However, coefficients suppressed during compression remain zero. The resulting DCT coefficient blocks are sparsely populated in a distinctive fashion: only a few relatively large values are concentrated in the upper left corner and many zeros in the right and lower parts.

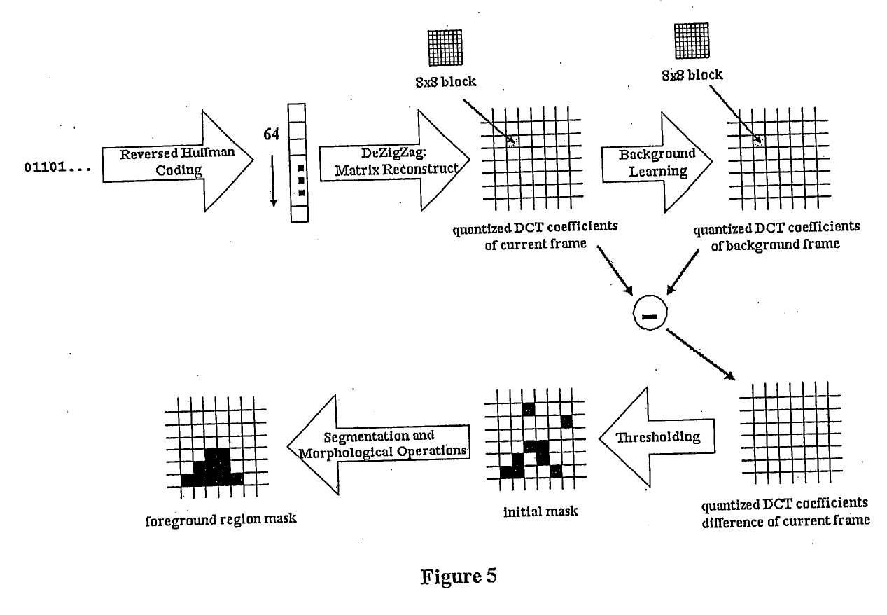

FIG. 5 shows the third approach of motion analysis and foreground/background separation. Instead of comparing current frame with previous frame, as shown in FIG. 3 and 4, a stored background frame is used to compare with the current frame. The background frame can be generated using standard background generation techniques. The paper “Stationary background generation: An alternative to the difference of two images,” W. Long and Y. H. Yang, Pattern Recognition, Vol. 23, No. 12, 1990, pp. 1351-1359, and the paper “Improvement of Background Update Method for Image Detector,” Y. J. Lim and Y. S. Soh, introduces many background generation techniques. Although these are based on uncompressed data, the techniques can be transformed to the compressed domain, by applying the techniques to the DC and AC components of the DCT coefficients instead of the pixel values. For example, let b(x,y) indicates the value of pixel (x,y) in the background image, and p1(x,y) indicates the value of pixel (x,y) in the first frame, and so on. By using an averaging method, b(x,y) will be equal to (p1(x,y)+p2(x,y)+. . . +pn(x,y)/n. Similar averaging can be performed on the DC and AC components of the DCT coefficients. The differences between the quantized DCT coefficients of the current frame and the quantized DCT coefficients of the stored background frame are calculated and thresholded to generate the initial mask. This initial mask will be further processed by segmentation techniques and morphological operations to find the foreground region. The quantized DCT coefficients of the current frame are also used in the-background learning process, as shown in FIG. 5. Part or all of the DCT coefficients of the current frame are utilized to update the stored background frame, depending on the background generation technique used.

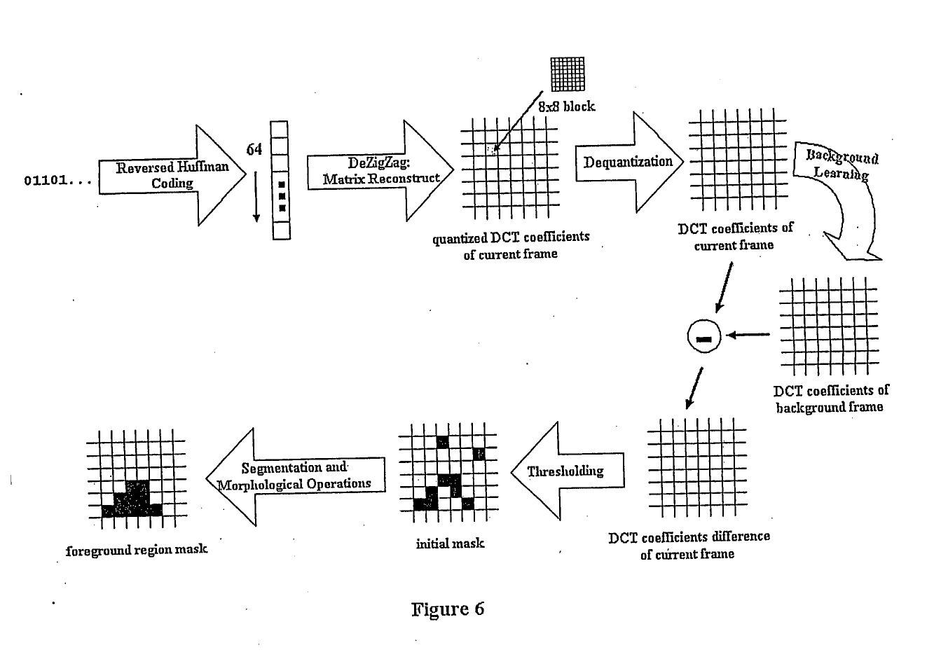

FIG. 6 shows another approach using stored background frame for motion analysis and foreground/background separation. The difference between this approach and the approach introduced in FIG. 5 is that dequantized DCT coefficients are used instead of quantized DCT coefficients. If computational constraints are a factor, quantized DCT coefficients are recommended in the compressed domain image processing. However, if the image processing unit of FIG. 1 has enough computational power, the dequantized DCT coefficients should be used for higher precision.

Compared with the approaches shown in FIG. 5 and 6, the approaches of FIG. 3 and 4 are less complicated because background learning is not involved. However, this also makes approaches of FIG. 3 and 4 inappropriate in some situations. In highway surveillance, if the highway is very busy and there is always something moving at any moment, the approaches of FIG. 3 and 4 cannot find an image frame without motion and identify that frame as the background frame. In such situations, approaches of FIG. 5 and 6 should be used because a background frame can be generated through background learning. The generated background frame can be saved into the data storage unit and send to the network with the foreground data.

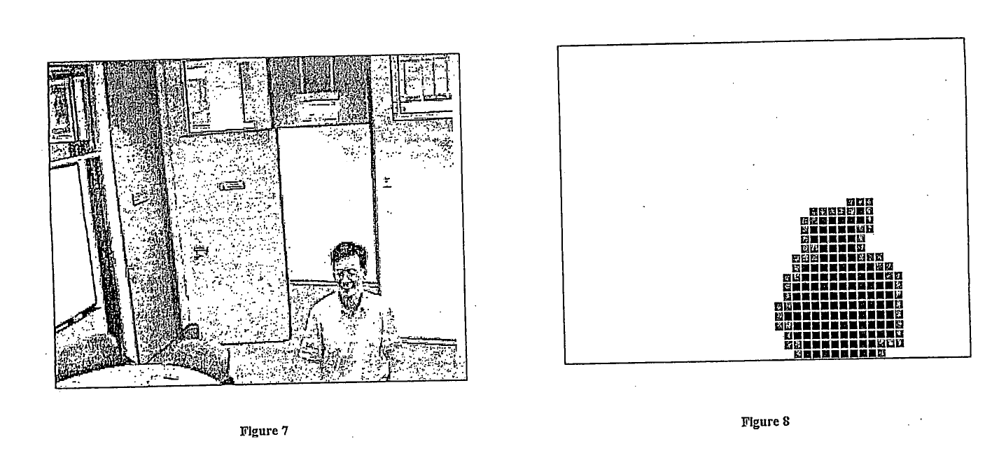

FIG. 7 is an example of an original image with FIG. 8 being the, segmented foreground blocks corresponding to FIG. 7, using the motion analysis and foreground/background separation approach shown in FIG. 3. The blocks of the segmented foreground region are represented by black blocks, as shown in FIG. 8. The blocks of background region are shown in white. From the figures, it can be easily observed that the person entering the room is identified as foreground region and is nicely separated from the background region (the room, door, table, chair, and other static items). From the figures, it can also be observed that the area occupied by the foreground region is less than one eighth of the entire image area. By transmitting only the foreground region, valuable bandwidth will be saved. In order to control the transmitted image quality, a control parameter ‘padding value’ is introduced here. The padding value is a positive integer. It can be as small as zero. If the padding value is one, the segmented foreground region will be enlarged by one block, as shown by the grey blocks in FIG. 8. These padding blocks (grey blocks) will be treated as part of the foreground region, and will be later saved into the storage unit and transmitted through the network. By adding padding blocks to foreground region, we can make sure that all the important image details related to the foreground region are preserved and transmitted. The padding value can be adjusted according to the network traffic detected by the traffic detection unit of FIG. 1.

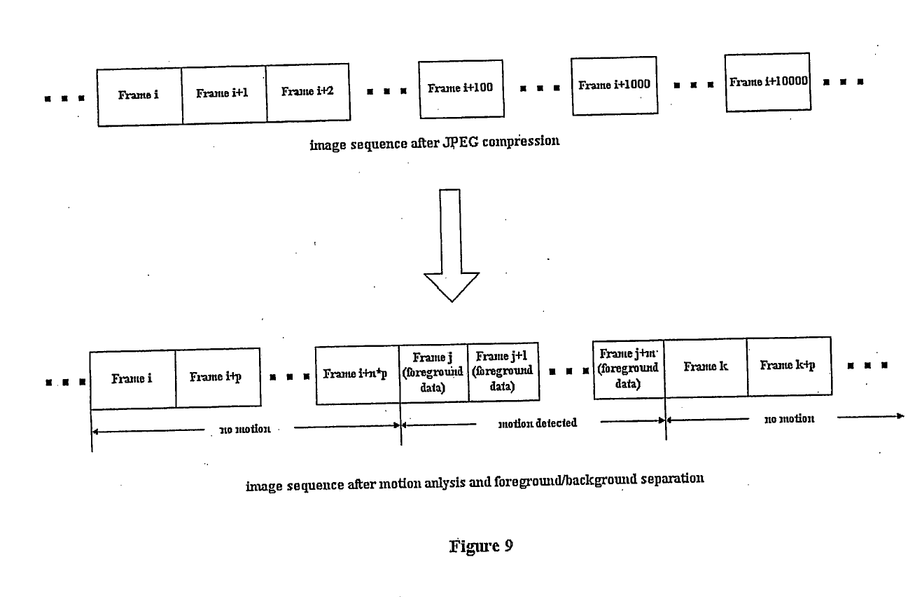

FIG. 9 shows an image sequence after JPEG compression and the corresponding image sequence after motion analysis and foreground/background separation. From the figure, it can be observed that the image sequence after motion analysis and foreground/background separation during the no-motion period is not the same as the image sequence after JPEG compression. According to the previous description, if no motion is detected in an image frame, the image frame is identified as a background frame and the whole JPEG-compressed image will be saved into the storage unit and used for lo transmission. However, not all the image frames during the no-motion period are kept. Since there is no motion, the frames of no-motion period should be similar and there is no need to keep all of them. In the preferred embodiment of the present invention, a background dropping scheme is used which works in such a way: if frame i is identified as a background frame and saved into the data storage unit, the following p frames will be dropped unless one of them is identified as a foreground frame. After throwing away p background frames, the next frame—frame i+p will be kept and saved into the data storage unit. The parameter p can be adjusted according to the network traffic detected by the traffic detection unit of FIG. 1. During the motion period, the foreground data of every foreground frame are saved into the data storage unit. Using this technique, more bits can be allocated to frames with motion and less bits to frames which are scarcely changed.

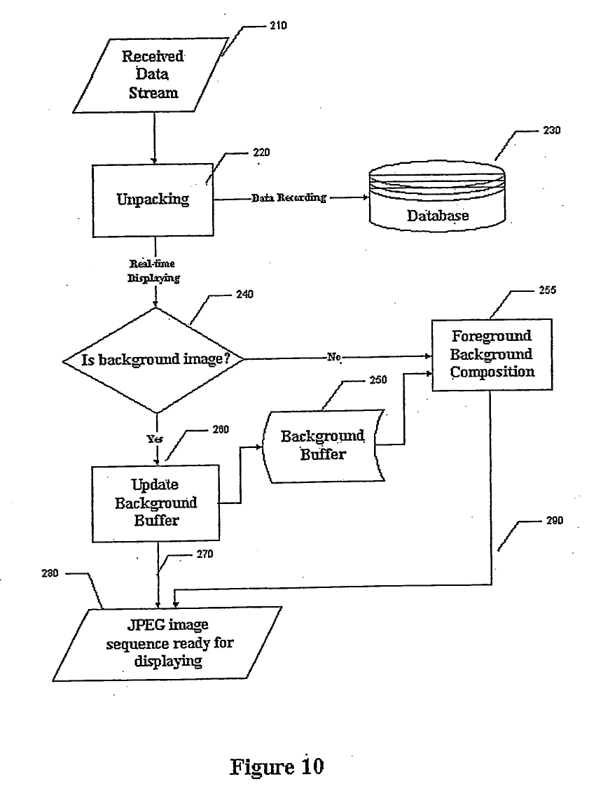

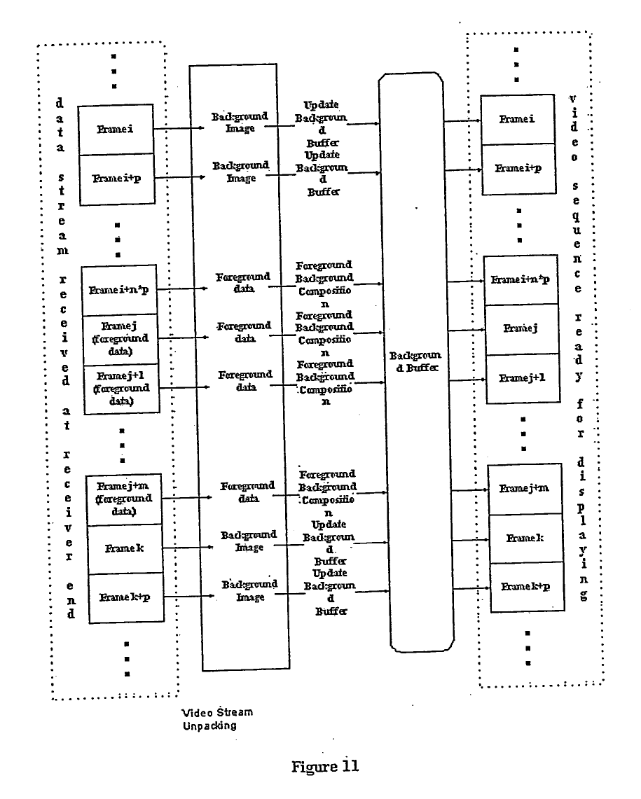

FIG. 10 and FIG. 11 describe the operations performed at the receiver side in which the separated foreground/background data can be stored or displayed like a normal JPEG or MJEPG sequence at the receiver side. FIG. 10 gives the block diagram of the operations performed at the receiver side. The received data stream 210 consists of continuous binary data which belongs to different frames. It is therefore necessary to divide the received data stream into segments so that each segment of data belongs to one image frame. This process is called unpacking 220. The data after unpacking is now ready to store in a database 230 of the receiver side. This is normally required in a central monitoring and video recording environment. Note that the data after unpacking is not a normal JPEG sequence. It's a combination of compressed background data (normal JPEG image) and foreground data. The foreground/background composition can be used to convert the foreground data into normal JPEG images. However, that will cost more storage space and preferably the foreground/background composition is performed only when necessary, that is, when it is desired to view the image sequence. The displaying of image sequence can happen in two modes. The first mode is the real-time displaying of the data stream received from the network. The second mode is to playback the image sequence stored in the database. Although the data sources are different, these two modes operate in a similar way as follows:

For displaying the image sequence, it is necessary to find out the types of each image frame. The header of each image frame data is arranged to contain data enabling a decision to be made whether the image frame is a background frame or a foreground frame at 240, for example by adding one bit of data to the image frame header having the value 1 for a background frame and 0 for a foreground frame. If an image frame is a background frame, it will be used at 260 to replace the background image data stored in a background buffer 250 of the receiver. Using a standard JPEG decoder, the background image frame can be decoded and displayed directly at 270,280. If an image frame is a foreground frame, foreground/background composition 255 is needed to display the image correctly. The foreground/background composition will take the background image data from the background buffer 250 of the receiver, use the foreground block data in the foreground frame to replace the corresponding blocks of the background image, and form a complete foreground JPEG image for display at 290,280. As the foreground/background composition only involves replacing background blocks with foreground blocks, the computational complexity is minimized at the receiver side. FIG. 11 takes the-image sequence of FIG. 9 (after motion analysis and foreground/background separation) as an example, and illustrates how a normal JPEG image sequence is constructed using the above processing steps.

The embodiments described above are intended to be illustrative, and not limiting of the invention, the scope of which is to be determined from the appended claims. In particular, the image processing method disclosed is not solely applicable to surveillance applications and may be used in other applications where only some image data is expected to change from one time to the next. Furthermore, the described method although using JPEG compressed images is not limited to this and other compressed image formats may be employed, depending upon the application, provided semantics of the uncompressed image can be derived from the compressed data to allow a decision on whether a portion of the data has changed or not to be made. The camera shown need not be a network camera.

What is claimed is:

1. A method of processing image data comprising the steps of taking a compressed version of an image and determining from the compressed version if a change in the image compared to previously obtained image data has occurred and identifying the changed portion of the compressed image.

2. A method as claimed in claim 1, wherein the change is indicative of motion.

3. A method as claimed in claim 1, wherein the identifying step comprises identifying a foreground and/or a background region, the foreground region comprising moving object(s) and the background region comprising stationary object(s).

4. A method as claimed in claim 1, wherein the determining step is performed upon Direct Cosine Transformation coefficients of the compressed image.

5. A method as claimed in claim 4, wherein the coefficients are quantized or dequantized.

6. A method as claimed in claim 1, wherein a mask is formed of the identified portions.

7. A method as claimed in claim 6, wherein the mask is subject to segmentation and morphological processing.

8. A method as claimed in claim 1, further comprising the step of transmitting the compressed image or part thereof to a storage location.

9. A method as claimed in claim 8, wherein, if the image contains a changed portion, only the changed portion is transmitted and if the image does not contain a changed portion, the whole compressed image is transmitted.

10. A method as claimed in claim 9, wherein if consecutive images do not contain a changed portion, not all the unchanged images are transmitted.

11. A method as claimed in claim 10, wherein the number of consecutive unchanged compressed images that are not transmitted is determined by an adjustable parameter.

12. A method as claimed in claim 9, wherein the changed image portion and the unchanged image are transmitted at different rates.

13. A method as claimed in claim 1, wherein the previously obtained compressed image data comprises a previous compressed image.

14. A method as claimed in claim 1, wherein the previously obtained compressed image data comprises a stored background frame.

15. A method as claimed in claim 14, wherein the background frame is updated by background learning.

16. A method as claimed in claim 1, wherein the compressed version of the image uses JPEG or MJPEG compression.

17. A method as claimed in claim 1, wherein at least one step of a compression process used to form the compressed version is reversed prior to making said determination.

18. A method as claimed in claim 17, wherein the step comprises a coding step.

19. A method as claimed in claim 17, wherein the step is a vector-forming step.

20. A method of processing compressed data derived from an original image, the data being organized as a set of blocks, each block comprising a string of bits corresponding to an area of the original image, Direct Cosine Transformation (DCT) coefficients for each block being derived by decoding each string of bits, the differences between the DCT coefficients of the current frame and the DCT coefficients of a previous frame or a background frame being thresholded for each frame to produce an initial mask indicating changed blocks, applying segmentation and morphological techniques to the initial mask to filter out noise and find regions of movement, if no moving region is found, regarding the current frame as a background frame, otherwise identifying the blocks in the moving regions as foreground blocks and extracting the foreground blocks to form a foreground frame.

21. An image processor arranged to perform the method of claim 1.

22. A camera including an image processor as claimed in claim 21.

23. A network camera holding an image processor as claimed in claim 21.

24. Network camera apparatus including an image processor as claimed in claim 21 and further comprising an image acquisition means arranged to acquire an image in digital form, an image compressor arranged to compress the image and pass this to the image processor, data storage arranged to store image data from the image processor and communication means arranged to communicate with the network.

25. Network camera apparatus comprising an image requisition unit arranged to capture an image and converts the image into digital format; an image compression unit arranged to decrease the data size; an image processing unit arranged to analyze the compressed data of each image, detect motion from the compressed data, and identify background and foreground regions for each image; a data storage unit arranged to store the image data processed by the image processing unit; a traffic detection unit arranged to detect network traffic and set the frame rates of the image data to be transmitted; and a communication unit arranged to communicate with the network to transmit the image data.

26. Apparatus as claimed in claim 24, wherein the recited elements of the apparatus are software programs or circuits.

27. Surveillance apparatus including a camera as claimed in claim 22.

28. A method of transmitting image data where the data has been split into foreground data and background data wherein the foreground and background data are transmitted at different bit rates.

29. A method as claimed in claim 28, wherein the bit rates are adjustable in dependence upon traffic over the transmission medium.

30. A method of forming a changed image from a previous image data and current image data identifying a change in the portion of the previous image comprising replacing a corresponding portion of the previous image data with the current image data to form the changed image.

31. A method as claimed in claim 30, wherein the previous image data is a previous image.

32. A method as claimed in claim 30, wherein the previous image data is a background image.
